(19) United States
(12) Patent Application Publication
(10) Pub. No.: US 2014/0034824 A1
(43) Pub. Date: Feb. 6, 2014

(54) METHOD FOR PRODUCING A CONVERTER MODULE AND CORRESPONDING CONVERTER MODULE

(71) Applicant: KROHNE MESSTECHNIK GMBH, Duisburg (DE)

(72) Inventors: Winfried KUIPERS, Essen (DE); Michael DEILMANN, Essen (DE)

(73) Assignee: KROHNE MESSTECHNIK GMBH, Duisburg (DE)

(21) Appl. No.: 13/772,391

(22) Filed: Feb. 21, 2013

(30) Foreign Application Priority Data
Aug. 3, 2012 (DE) 10 2012 015 205.1
Nov. 30, 2012 (DE) 10 2012 023 379.5

(51) Int. Cl. C25D 5/54; H01J 49/02

(52) U.S. Cl. CPC C25D 5/54; H01J 49/02
USPC 250/281; 205/162; 250/396 R

(57) ABSTRACT

A method for producing a converter module (1) a correspondingly produced converter module are improved by at least part of a structure (3) being produced on a carrier (2) forming a component of the converter module (1) and by a material containing metal being at least partially applied on the carrier (2).

### BACKGROUND OF THE INVENTION

1. Field of the Invention

The invention relates to a method for producing a converter module and further comprises a correspondingly produced converter module.

2. Description of Related Art

To control processes optimally or to be able to already reliably measure with small sample amounts, sensors and actuators are often produced by means of micro-systems technology in the modern prior art. Such small converters or converter modules—as a general term for sensors and actuators—can be produced inexpensively in large quantities and also allow for easier modification of a measurement device than a normal converter. The converter module made according to the invention is, for example, a part of a field device, which is itself designed as a measuring device or as an actuator.

Integrated circuit packaging is also referred to by many as the most labor-intensive and expensive step in the fabrication of devices based on micro systems technology. In particular, the fluidic connection (fluid meaning, here, any flowable medium, e.g., partially liquid or gaseous medium) is difficult, for example, in lab-on-a-chip systems.

Methods known from the prior art from the field of electrical integrated circuit packaging are wire bonding or tape automated bonding (TAB). Another possibility is the use of through-silicon vias. The fluidic connections from micro system to macro fluidic system are either glued, soldered, eutectic alloy, or connected with the help of a removable seal. It must be ensured that the respective connection meets the chemical, thermal and mechanical requirements of the implementation.

Flip-chip technology, for example, allows for the simultaneous soldering of the electrical and fluid connections.

As a carrier for structures with electrical or fluidic functions that require a corresponding connection to the macroscopic periphery, ceramics are often used that may be executed in multiple layers and, inside of which, structures like cavities, channels, wire or electrode structures are already located.

Low temperature co-fired ceramics (LTCC) are used to produce multi-layer ceramic structures. Thereby unfired—so-called green—ceramic films are individually structured, stacked, laminated and subjected to a sintering profile with a peak temperature of about 850° C.-900° C. For unfired ceramic films, the usual technical term “green ceramic films” is always used in the following. In sintering, maximum-occurring temperatures distinguish the LTCC method from the generation of high-temperature co-fired ceramics (HTCC), which are sintered at temperatures between 1600° C. and 1800° C. Thick-film hybrid techniques are further known, wherein conductor paths or resistances are applied to previously-sintered ceramic substrates using a screen printing method. The printed substrate is fired, wherein the applied pastes melt into layers. Then, the possible mounting of discrete components takes place.

Further structures can be mounted on these ceramics, e.g., can be soldered or mechanically clamped, etc.

A known process for the production of structures is the so-called LIGA method. In this method, lithography (e.g., by means of X- or UV-radiation), combines electroplating and micro-molding. An advantage of the LIGA technology lies in the production of channels having a high aspect ratio (ratio between the depth and width of the channels). Furthermore, high precision and resolution result. One variation is the direct LIGA, wherein the electroplated metal structures do not form the mold, but rather the micro-functionality itself. The structures of precious metal also provide a higher chemical resistance than the silicon electrode according to the prior art.

An ion-optical use is, for example, the miniaturized mass spectroscopy, wherein at least one function is implemented in microsystems technology. In mass spectroscopy, mixtures are separated according to molecule mass and the concentration is determined per mass. Since the measurement process takes place in a vacuum, a vacuum connection must be implemented in addition to the sample inlet. Moreover, there are many voltage and current signals. A particular design combines the entire miniaturized mass spectrometer functionality on one chip. The different components are housed in a plane specified by photolithography and thus automatically calibrated to one another.

In the prior art, one variation for the production of micro mass spectrometers uses silicon-glass micro-engineering. The individual components, sections and structures are thereby generated using photo-lithography and DRIE (deep reactive ion etching) in a silicon plane enclosed by glass planes. A fundamental disadvantage results from the poor chemical resistance of silicon to oxygen. The electrically non-conductive silicon oxide, which is formed in succession on the electrode surfaces, prevents an optimum electrical manipulation of the ions. Another disadvantage is the complicated connection to the electrical, fluidic and—if available—thermal peripherals, since appropriate connection elements must be lead laterally-outward. The fluidic connections are formed, for example, by gluing glass capillaries into the silicon plane. This process is very labor intensive and also the adhesive required for this purpose is often not sufficiently stable chemically.

### SUMMARY OF THE INVENTION

Therefore, primary object of the present invention is to provide a method for manufacturing a converter module, which is an improvement over the prior art.

This object is achieved in accordance with the method according to the invention essentially in that at least part of a structure is produced on a carrier forming a part of the converter module, and in that a material containing a metal is at least partially applied on the carrier. In one design, essentially only metal is applied for the production of the structure. The structure refers, in general, to the objective forms, components, or elements, or components thereof, which serve or support the function of the converter module.

In one design, in particular, such a structure is created that has an aspect ratio—the ratio between the depth or the height and the corresponding width—that is greater than 10. In a further design, an aspect ratio that lies between 10 and 15 is obtained. Alternatively or additionally, dimensions in the micrometer range at least partially are found in the structure.

A combination of the lithography and electroplating methods is used for generating at least a portion of the structure—i.e., the direct LIGA method—, wherein the structure is thereby produced directly on the carrier.

In one design, the carrier is at least partially produced as a ceramic component, wherein, in one design, at least a sintering method is applied during production. Alternatively, the carrier is already a ceramic component already appropriately produced or designed, for example, by means of LTCC technology, on which the structures of the converter module are produced by means of the LIGA method.

One design provides that at least one transmission element—in particular, for the transfer of heat and/or electric current and/or electric voltage—is introduced in the carrier. The transmission element is, in one design, an electrical conductor, and in an additional or alternative design, a thermal conductor. The at least one transmission element is made, in one design, at least partially of a metal.

The at least one transmission element is, in one design, in particular, an electrical and/or thermal connection for the converter module. It is essential, here, that the at least one transmission element or the transmission elements goes/go through the carrier. In the prior art, the carrier is typically glass, so that such connections have to be led in or out on the side. This shows an advantage of the combination of direct LIGA and LTCC technology used for the production of the converter module over the silicon-glass technology according to the prior art.

The use of LIGA or direct LIGA technology based on LTCC technology allows for the implementation of thermal functionality as a part of the converter module in addition to an electric and/or fluidic functionality. The heat, which is created by the use of the converter element, e.g., mainly by an electron source of a micro mass spectrometer as a type of converter element, can be effectively dissipated to a heat sink by means of thermal through vias in the ceramic multilayer substrate.

In one design, the thermal connection is connected simultaneously with the electrical and fluid connections by means of flip-chip technology. Such dissipation of the heat could not be implemented in a converter element prepared according to the prior art as a silicon-glass-converter. The possibility of simultaneously generating even all the electrical, thermal and fluidic connections by means of flip-chip technology in one embodiment, is, in particular not possible with the silicon-glass technology of the prior art.

In a further design, the heat sink can be integrated in the form of a heat exchanger, for example, as a meandering channel for a cooling liquid or as a Peltier element in the carrier.

In a further design, in particular, the guiding of the electrical or thermal transfer elements through the carrier is utilized in that the number of connections is reduced by a merging of the individual contacts to form a transmission element or a few common transmission elements. Thus, in one design, the applied multi-layer technology allows for the merging of different electrodes that are exposed to the same signal using the channels or through vias generated during production, minimizing the number of peripheral electrical connections.

In a further design, alternatively or in addition to the above design, at least one channel—in particular, for guiding of flowable and/or gaseous media—is introduced in the carrier element. The channel or possibly channels allow, for example, substances that are required or disturbing for the method implemented in the converter module, to be introduced into the converter module, such as a measuring medium or an auxiliary gas, and/or discharged up to the point of a high vacuum in the system. For example, a measuring medium is ionized in the converter module by means of a supplementary gas at low pressure. In a further embodiment, cooling is implemented by the supply and discharge of a cooling medium via the at least one channel.

As a method of producing the carrier that could consequently already have their own structures, recesses, connections, lines, etc., it is recommended, thereby, to use the methods that lead to LTCC or HTCC carriers. In one design, therefore, the structure required for the converter element is applied to a LTCC or HTCC carrier by means of direct-LIGA. By combining LTCC or HTCC and direct LIGA, a further improvement is achieved. On the one hand, the connection to the electric and fluidic periphery of the module is simplified (e.g., using flip-chip technology) by the use of LTCC or HTCC. On the other hand, the chemical resistance of very small electrodes with highest aspect ratio is ensured due to direct-LIGA. Initially, the LTTC or HTCC system is produced with electrical and fluidic functionality and then the metallic structure is applied by means of direct-LIGA, so that a metallic structure results directly on a ceramic.

In one design, the surface structure of the carrier is at least partially processed prior to application.

Furthermore, in a further embodiment, the stability of the structure is increased in that the structure and/or the surrounding surface of the carrier is/are at least partially coated with at least one coat (e.g., with a precious metal).

In order to improve the production and further enable a cost reduction, it is provided in one embodiment that the structure is produced, while the carrier is located within a utility. Thus, multiple converter modules can be generated simultaneously.

In one embodiment, at least one electronic component is introduced. Due to the application and the corresponding electrical contact of the component, a hybrid integration of electronics results in the multi-layer ceramic of the converter module produced according to the invention. The at least one electrical component is, in this case, for example, located on the carrier element and/or between the structures produced. Thus, for example, current measurement, steepening of the square waves for the mass filter, and/or temperature control on the basis of integrated thermistors and heating resistors can be implemented already with the converter module and in particular the integrated electronic components are used as part of the converter module. The electronic component is, for example, a resistor element, a coil, a capacitor or a part of a more complex circuit.

The invention further relates to a converter module, which is made according to one of the aforementioned designs of the method according to the invention.

In one design, the converter module is a mass spectrometer.

Generally a mass spectrometer can be divided into three sections with different functionalities: These are the ionization of the sample under investigation, a separation of the various ions according to their mass and a quantification of the separate ions according to their mass as actual detection.

For manipulation of the ions, magnetic and/or electric fields are used. The electric fields are produced with the aid of electrically conductive electrodes. In order to ensure a path length long enough for the ion, at least the mass separation and detection and optionally also the ionization take place in a vacuum.

According to the invention, the mass spectrometer is produced by a combination of direct LIGA and ceramic multi-layer technology (e.g., LTCC or HTCC). Here, at least one of the above-describe method variations is used in the implementation.

In one design, a ceramic multi-layer substrate as carrier allows connection to the electrical (e.g., DC potentials for the manipulation of the ions), fluidic (e.g., sample collection and vacuum system) and thermal (e.g., heat sink) peripherals and serves as a substrate for the particular (precious) metal structures of the mass spectrometer functionality, which are applied by direct LIGA.

Structures produced by means of the LIGA process are provided, in one design, with a cover for the implementation of different pressure levels and possibly the completion of a hermetically sealed vacuum chamber by means of bonding, soldering, welding, eutectic alloying or a similar process.

In detail, there are now a variety of possibilities for designing and further developing the method according to the invention and the converter module according to the invention as will be apparent from the following description of embodiments in conjunction with the accompanying drawings.

### BRIEF DESCRIPTION OF THE DRAWINGS

FIG. 1 is a schematic, sectional representation of a converter module,

FIG. 2 is a schematic top view of two converter modules during their production, and

FIG. 3 shows a micro mass spectrometer according to the invention, as an example of a converter module, in a partly exploded view.

### DETAILED DESCRIPTION OF THE INVENTION

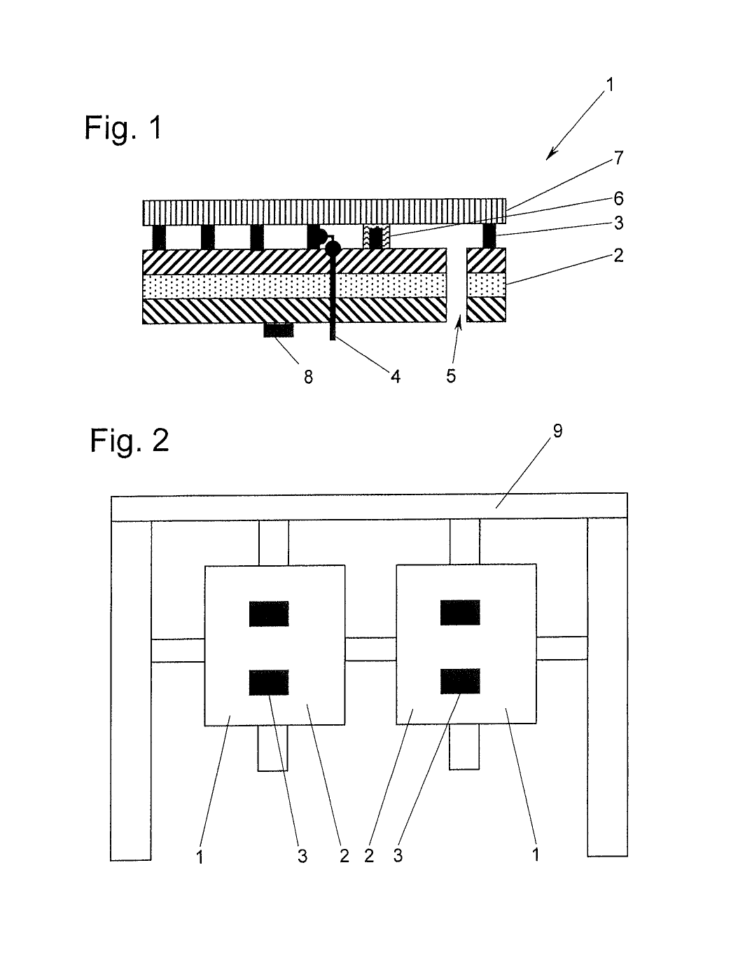

FIG. 1 shows a converter module 1, purely schematically and not to scale, simply to provide a fundamental understanding of a, here, three-layer carrier 2, which is produced, for example using the LTCC method. A structure 3 of metallic elements is produced on the top side of the carrier 2 by means of direct LIGA. A portion of the structure 3 is connected to a transmission element 4, which is guided by the carrier 2 and which is used, in this example, as a kind of heat pipe for the heat dissipation from the portion of the structure 3. A vertically extending channel 5 stretches further through the carrier 2, which can be used to feed a sample medium.

A portion of the structure 3 is surrounded by a coating 6, which offers increased protection against the process. In this embodiment, a closing cover 7 is provided above the structure 3 that is used in guiding fluids or electrical signals, or stabilization, the closing cover, for example, being required in a converter module 1 designed as mass spectrometer.

An electronic component 8 is located below the carrier 2, and thus, on the side facing away from the cover 7, which assumes the tasks of activation, power supply and/or at least pre-processing in direct proximity to the measuring and/or actuating unit implemented by the structure 3.

In FIG. 2, two converter modules 1 are schematically shown during their production. Thereby, the support members 2 are located in a fixture 9, which allows for the structures 3 to be simultaneously mounted in one procedure for multiple converter modules 1. The illustration is purely schematic and not to scale. In particular, the fixture 9 is preferably designed so that it has no large holes, since, for example, photoresist is to be applied on the surface for the LIGA process.

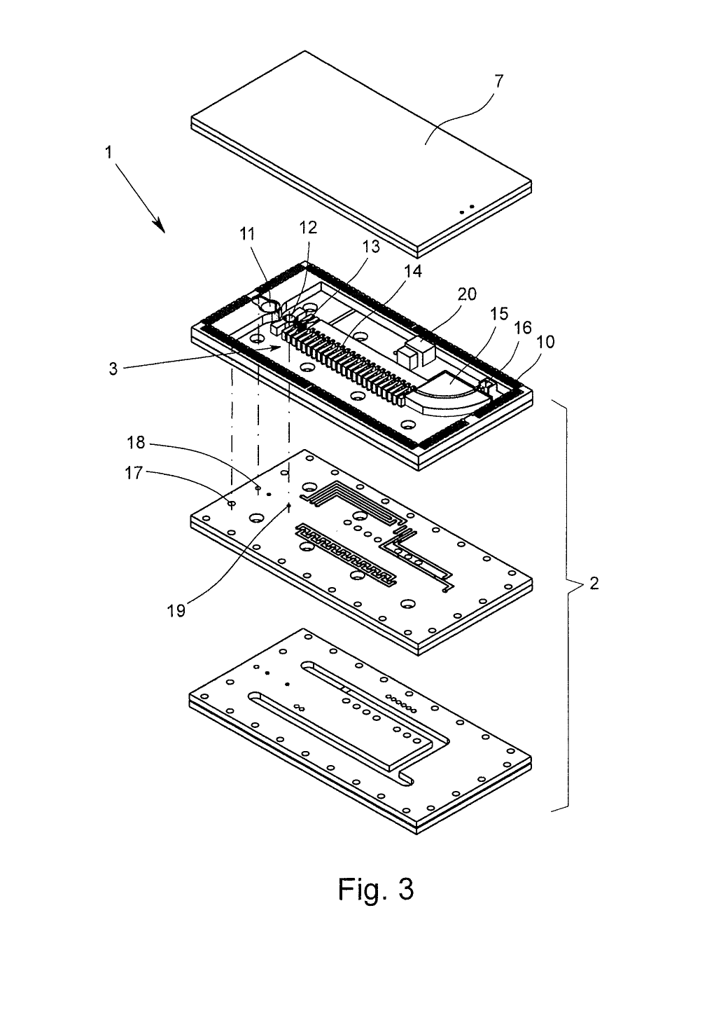

FIG. 3 shows, partially exploded, a micro mass spectrometer as an example of a converter module 1 according to the invention. For better understanding, simplifications have been made. The number of levels and layers, etc. are also purely exemplary. In this example, the function of a mass spectrometer with components present in the LIGA structure layer 10 will be explained below.

The ionization of the sample to be examined—not shown here—of measuring medium occurs by means of electron impact. For this, electrons from a microwave plasma of an electron source 11 are accelerated towards an ionization chamber 12. The ions of this ion source are then accelerated into the mass separator 14 as a collimated parallel beam with the help of ion optics 13. The following applies in general, that at a constant acceleration voltage, the velocity of the ions is a root function depending on the ratio of charge to mass.

Square wave signals are applied to the finger electrodes of the separator 14, which alternate both in time as well as space in one embodiment. This is used to adjust a field-free window, which moves with a certain velocity through the separator 14. Only ions of a specific mass that move with the field-free window through the separator 14 reach the next stage. Ions having a different mass are deflected toward the electrodes and neutralized there.

An energy filter 15 is located behind the separator 14 in the form of an electric sector field.

Finally, the mass-separated ions are quantified using a Faraday detector 16.

The microwave plasma is excited in this example with a high frequency signal, e.g., having a frequency of 2.45 GHz, with respect to mass. The multi-layer ceramics of the converter module 1 allow for a customized and low-loss transmission of the high-frequency signal.

The heat generated by the plasma is removed downwardly away to a heat sink via a ground connection and thermal vias 17.

For optimized thermal management, ceramic composites with high aluminum nitrite content are used in a further embodiment. It is essential that the aluminum nitrite has a thermal conductivity greater than 200 W/(m*K) in relation to aluminum oxide having a thermal conductivity between 20 and 30 W/(m*K) or borosilicate glass with a thermal conductivity of about 1 W/(m*K).

DC potentials in the range of ±100 V are applied in the ionization chamber 12 and to the electrodes of the ion optics 13. Each potential is symmetrical on both sides of the ion trajectory. The terminals of the electrode pairs are preferably connected to one another via conductors inside the multi-layer ceramics so that only one connection to the voltage source is sufficient for each signal.

The comb-shaped structure is normally connected to ground on the one side of the mass separator 14, and thus, enables thermal contact with the heat sink. The finger electrodes on the other side of the mass separator 14 are usually alternately driven with two square waves inverted relative to one another. Electrodes that are supplied with the same signal are also connected to one another via a conductor within the interior of the multi-layer ceramics of the converter module 1, so that one connection to a signal generator—not shown here—is sufficient per signal.

The quality of the mass separator 14 depends, inter alia, on the quality of the signals, with which the finger electrodes are driven. Since the converter module 1 can also be used as a circuit board in the form of multi-layer ceramics, the possibility arises of providing a signal-enhancing circuit—in particular, a partitioning stage—adjacent to the separator 14, e.g., on the bottom of the module 1, and even using larger electronic components.

Within the three-layer carrier 2, electrical 18, fluid 19 and thermal lines or connections 17 leading to the underside of the module 1 can be identified. This allows for a connection of the module 1 to a peripheral similar to flip-chip technology, wherein all connections can be implemented simultaneously.

The module 1 can be soldered, for example, as an SMD (Surface Mounted Device) component fixed on a macroscopic substrate, which, all in all, provides the necessary electrical signal, which is used as an interface to a vacuum system, a plasma gas reservoir and for sample supply and which also functions as a heat sink or exchanger.

For a simple as possible replacement, it is advantageous when the module is detachably connected to the macroscopic substrate. Thus, multi-pin connectors can be used for low-frequency signals, wherein, e.g., a connector is soldered directly or via a (flat) cable to the module 1. Since gas supply is usually based on capillary technology and especially the sample gas is to be supplied with zero dead volume, preferably a seal on the basis of ferrules is provided for the connection. The necessary conical inlets can be implemented using molding or stamping, also in ceramics. Therefore either a molded part is laminated before sintering the unsintered ceramic multilayer and then fired. Or holes are conically deformed in an unsintered multilayer ceramic by means of stamping. Alternatively, a flat surface of the module can be used for sealing, wherein the conical recesses are implemented in the macroscopic counterpart.

The cover is located above the layer 10 generated by the LIGA process. The cover 7 allows at least different levels of pressure and, in one embodiment also a limited, hermetically sealed vacuum chamber.

For the variation of the converter module 1 as an analyzing device, the cover 7 is particularly attached with joining techniques such as soldering, welding or eutectic alloying. Since these methods take place at elevated temperatures, thermal stress can occur due to different thermal expansion coefficients of ceramic and metal. To minimize this, not all of the lid 7, but only the joining area, is heated to the required temperature.

An implementation of the attachment only in sections provides that the cover 7 is implemented in ceramic multilayer technology, wherein thermal resistors are integrated in the region of the joining points.

The design of the cover 7 as multi-layer ceramics allows for an easier adaptation to underlying components, such as the electronic component of a power amplifier circuit 20, which projects beyond structures 3 produced by means of direct LIGA.

What is claimed is:

1. Method for producing a converter module, comprising the steps of:
generating at least part of a structure on a carrier forming a component of the converter module and
at least partially applying a material containing metal on the carrier.

2. Method according to claim 1, wherein the structure is produced at least partially with an aspect ratio of depth to width that is greater than 10.

3. Method according to claim 1, wherein at least a part of the structure is produced on the carrier by the direct lithography and electroplating (LIGA) process.

4. Method according to claim 1, wherein the carrier is at least partially produced as a ceramic component.

5. Method according to claim 4, wherein at least one sintering process is applied during production of the carrier.

6. Method according to claim 4, wherein at least one transmission element for the transfer of at least one heat, electric current and voltage is introduced into the carrier.

7. Method according to claim 4, wherein at least one channel for guiding of at least one of flowable and a gaseous media is introduced into the carrier.

8. Method according to claim 1, wherein at least one electronic component is applied to the carrier.

9. Converter module produced by the method according to claim 1.

10. Converter module according to claim 9, wherein the converter module is a mass spectrometer.

11. Converter module according to claim 9, wherein a portion of the structure is connected to a transmission element which is guided by the carrier.

12. Converter module according to claim 11, wherein the transmission element is adapted for the transfer of at least one heat, electric current and voltage.

13. Converter module according to claim 12, wherein the converter module is a mass spectrometer.

14. Converter module produced by the method according to claim 2.

15. Converter module according to claim 11, wherein the converter module is a mass spectrometer.
